(19) United States
(12) Patent Application Publication
(10) Pub. No.: US 2006/0082137 A1
(43) Pub. Date: Apr. 20, 2006

(54) Leadthrough device

(76) Inventor: Herbert Muenzenberger, Wiesbaden (DE)

Correspondence Address: ABELMAN, FRAYNE & SCHWAB, 666 THIRD AVENUE, 10TH FLOOR, NEW YORK, NY, 10017, US

(21) Appl. No.: 11/225,731

(22) Filed: Sep. 12, 2005

(30) Foreign Application Priority Data
Sep. 11, 2004 (DE) 10 2004 043 970.2

(51) Int. Cl. F16L 39/00

(52) U.S. Cl. 285/124.5

(57) ABSTRACT

A leadthrough device (1; 11; 21) for passing a conducting element (10) through an opening (8) formed in a constructional component (9) includes an elastic sealing member (3; 13; 23) having at least one through-opening (5; 15; 25, 26, 27, 28) and a removable guide sleeve (4; 14; 29, 30, 31, 32) arranged in the at least one through-opening (5; 15; 25, 26, 27, 28) and outer dimensions of which exceed inner dimensions of the at least one through-opening (5; 15; 25, 26, 27, 28) in a non-inserted condition of the guide sleeve.

### BACKGROUND OF THE INVENTION

1. Field of the Invention

The present invention relates to a leadthrough device for passing a conducting element through an opening formed in a constructional component and including an elastic sealing member having at least one through-opening.

2. Description of the Prior Art

For passing conducting components such as e.g., of cables or tubular conduits through constructional components such as walls, ceilings and the like, in the constructional components, there are provided openings which should be fireproof and flue gastightly closed to prevent, in particular, spreading of fire in case of fire, or of flue gases through the openings. Numerous leadthrough devices, in particular, for a fireproof and flue gastight passing of conducting elements through openings in the constructional components and which includes a sealing member with at least one through opening, are well known.

European Publication EP 0 429 916 A2 discloses, e.g., a modular device for sealingly passing of conducting elements and having a sealing member which is formed of two parts, with each part having, on its side adjacent to another part, a semicylindrical recess. In the space that is formed by the two semicylindrical recesses, there is arranged a cylindrical sealing body the diameter of which is smaller than the diameter of the semicylindrical recesses. The remaining space is filled with a hollow cylinder that is longitudinally divided in two substantially equal semicylinders which are formed of several, arranged one on the other, detachable from each other, layers.

British Publication GB 2 186 443 A discloses a further modular device with two-part sealing members and with hollow cylinders which are formed of several, concentric, arranged on each other, and detachable from each other, layers. The sealing member is located in a frame with a clamping device. This device can be used in shipbuilding for fluidtight closure of openings.

The drawback of the devices described above consists in that a large number of separate components is needed for forming a device, which should be stacked one upon another to close an opening, which is very expensive. In addition, the passing-through conducting elements should be placed in the device already when the device is only formed. If only sections of the conducting elements should be placed in the produced device, at both sides of the constructional component, connections should be provided which are undesirable from both constructional and aesthetic points of view.

German Publication DE 39 43 165 A1 discloses a device for fireproof closing of a leadthrough in a constructional component and having a frame and a shaped element. The shaped member has punched through-openings which are closed with stamped elements. For passing a conducting element, the stamped elements are removed, and the conducting element is passed through. All intermediate clearances between the conducting element and the shaped member are closed with a sealing mass.

The drawback of the above-described leadthrough device consists in that the closing of intermediate spaces is very expensive. In comparison with inner dimensions of the through-opening, the outer dimension of the passing-through conducting element are greater. Therefore, when a conducting element is passed through the device, an increased friction resistance takes place, which interferes with the passing of the conducting element through, which can lead to the damage of the shaped member. To insure a flue gas tightness, all clearances should be closed with a sealing mass.

German Utility Model DE 298 18 819 U1 discloses a device for a fireproof closing a leadthrough in a constructional component and in which an elastic sealing member, which surrounds the conducting element is pressed by two locking plates so that it sealingly engages the reveal of the leadthrough and the outer surface of the conducting element.

The drawback of the device of the German Utility Model consists in that loading of the locking plates without increased costs, is possible only with easy accessible openings. Furthermore, the device is suitable for passing through of only one conducting element.

U.S. Pat. No. 4,302,917 discloses a device for a fireproof and flue gastight passing of a conducting element through an opening in a constructional component with which the sealing member is cast in or placed in the constructional component. With a hollow cylindrical punching tool having a conical tip, a through-opening is formed in the sealing member for the passing-through a conducting element. The conical tip is removed, and the conducting element is passed through the opening which was formed with the punching tool. Finally, the punching tool is pulled out of the sealing member in a direction opposite the insertion direction of the conducting element with the expanding sealing member tightly engaging the conducting element over its circumference. The hollow cylindrical punching tool can be formed, e.g., of two half-shells in order for the tool to be easily removed from the sealing member.

The drawback of the device of U.S. Pat. No. 4,302,917 consists in that for forming the through-opening in the sealing member, a punching tool and a suitable device for operating the same are necessary.

Accordingly, an object of the invention is to provide a leadthrough device for passing a conducting element through an opening in a constructional component which would insure an easy passing of conducting element through the device independent on the progress of the construction.

Another object of the present invention is to provide a leadthrough device for passing a conducting element through an opening in a constructional component and which would insure a flue gastightness of the opening.

### SUMMARY OF THE INVENTION

These and other objects of the present invention, which will become apparent hereinafter, are achieved by providing a leadthrough device of the type described above and having a removable guide sleeve arranged in the one through-opening of the sealing member and having outer dimensions that exceed inner dimensions of the through-opening in the release condition of the sealing member.

Because the outer dimensions of the removable guide sleeve exceed the inner dimensions of the through-opening of the sealing member in the release or removed condition of the sleeve or release condition of the sealing member, the sealing member is compressed at least in the region of the guide sleeve when the guide sleeve is inserted in the rough opening of the sealing member.

The passing conducting element can be easily passed through the guide sleeve. After the conducting element has passed through, the guide sleeve is pulled out of the sealing member. The elastically restorable sealing member expands, circumferentially engaging the outer wall of the conducting element. Thereby, the opening in the constructional component becomes flue gastightly closed, without need in any additional tool or in use of sealing mass to insure a flue gastight closing of the opening.

The elastic sealing member can be inserted in the opening of the constructional component, with an auxiliary device, if necessary, in a compressed state. The sealing member can have any cross-section, e.g., circular, oval, rectangular, or polygonal cross-section. The guide sleeve can also have a circular, oval, rectangular, or polygonal cross-section. Preferably, the cross-section of the guide sleeve is adapted to the cross-section of the passing-through, conducting element.

According to an advantageous embodiment of the present invention, the leadthrough device includes a frame in which the sealing member is arranged. The device can be cast in or placed in the constructional component as the constructional component being formed.

Advantageously, the guide sleeve is formed of several parts. After pulling of the conducting element through, separate parts of the guide sleeve can be removed from the conducting element, without a need for the guide sleeve to be pushed by the free end of the passing through conducting element. Dependent on the shape of the cross-section of the guide sleeve, it can be formed of two, three, four, or more parts.

According to an advantageous embodiment of the present invention, the guide sleeve is formed of two half-shells having a circular or oval cross-section.

Advantageously, several guide sleeves are arranged in the sealing member for passing through the sealing member several conducting elements. The guide sleeves in this case can have different cross-sectional dimensions and different cross-sectional profiles. Guide sleeves with a small cross-section, e.g., with a circular cross-section with a diameter of less than 1.5 cm, also can be removed from the sealing member. The elastically restorable sealing member expands, after the guide sleeve or sleeves has (have) been removed, closing the opening, whereby the flue gastightness of the device is insured.

Advantageously, the elastic sealing member is formed of an intumescent material that expands in case of fire, insuring a fireproof closing over the required fire protection period. Instead of an intumescent material, the elastic sealing member can be formed of another fireproof material which remains fire resistant at least for some time.

Advantageously, at least one removable closing element is provided in the guide sleeve. With a guide sleeve having a large cross-section, after the guide sleeve is removed from the sealing member, an opening can remain, despite the elastic restoration of the sealing member, through which flue gas can escape. With at least one removable closing element arranged in the guide sleeve, the flue gastight closing of the device takes place with the guide sleeve still located in the sealing member even without a lead-in line extending through the guide sleeve, while the possibility to put the lead-in line in the guide sleeve later still remains.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawing show:

FIG. 1 a longitudinal cross-sectional view of a first embodiment of a leadthrough device according to the present invention along line I-I in FIG. 2;

FIG. 2 a side view of the leadthrough device shown in FIG. 1 along line II-II;

FIG. 3 a longitudinal cross-sectional view of a second embodiment of a leadthrough device according to the present invention in the mounting condition of the device in a constructional component;

FIG. 4 a longitudinal cross-sectional view of a third embodiment of a leadthrough device according to the present invention along line IV-IV in FIG. 5; and

FIG. 5 a side view of the leadthrough device shown in FIG. 4 along line V-V.

### DETAILED DESCRIPTION OF THE PREFERRED EMBODIMENT

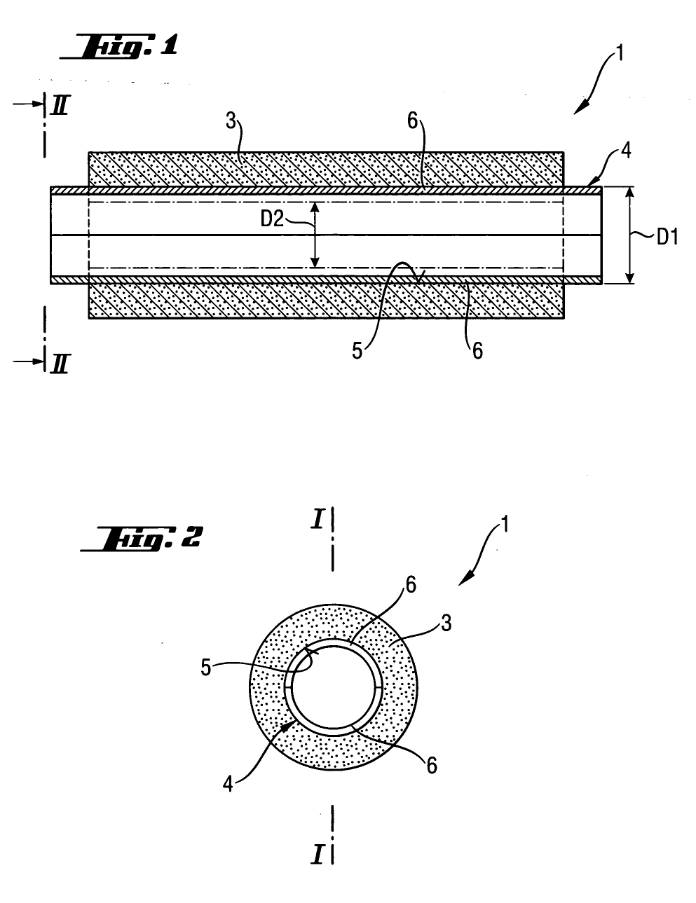

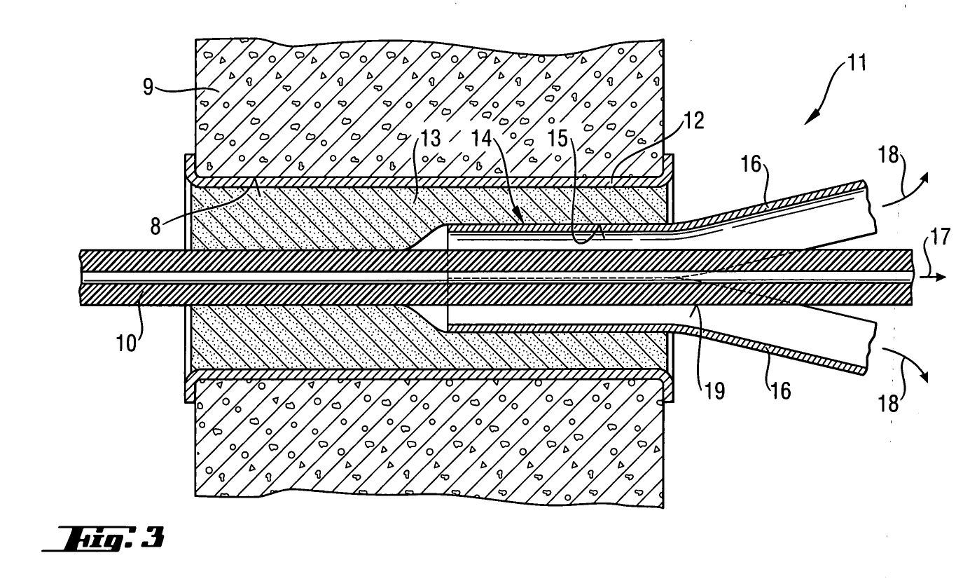

A leadthrough device 1 according to the present invention, which is shown in FIGS. 1-2, has an elastic sealing member 3 having a cylindrical cross-section and provided with a through-opening 5. A two-part removable guide sleeve 4 is arranged in the through-opening 5. The outer diameter 11 of the guide sleeves exceeds the inner diameter 12 of the through-opening 5 in the non-inserted condition of the guide sleeve 5. Thereby, the sealing member 3 is compressed at least in its region surrounding the guide sleeve 4 in the inserted condition of the guide sleeve. The guide sleeve 4 is formed of two half-shells 6, and is easily removable from the sealing member 3.

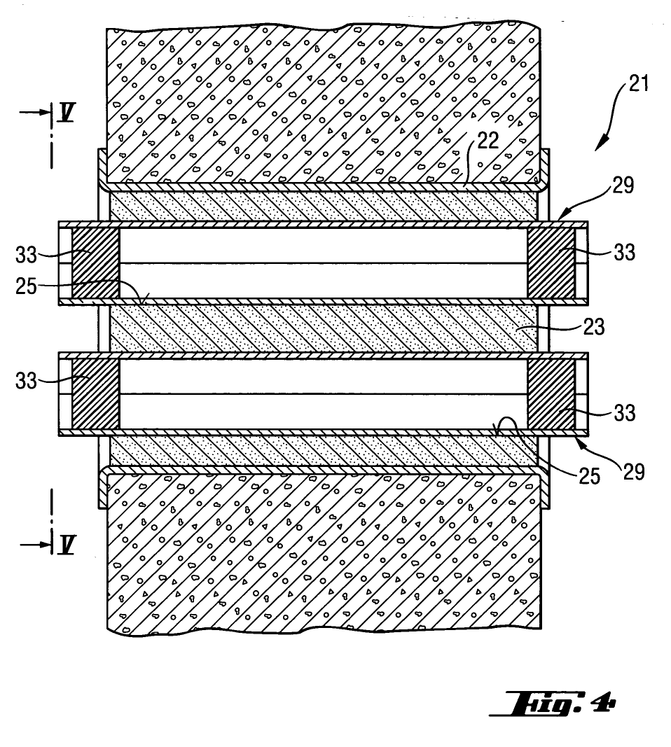

The leadthrough device 11 according to the present invention, which is shown in FIG. 3, is designed for a fireproof and flue gasproof passing therethrough of a conduit 10. The leadthrough device 11 is arranged in an opening 8 that is formed in a constructional component 9. The leadthrough device 11 differs from the leadthrough device 1 shown in FIGS. 1-2 in that it has a frame 12 in which an elastic sealing member 13, which is made of an intumescent material and has through-opening 15, is arranged. In the through-opening 15, a guide sleeve 14 is arranged. The guide sleeve 14 is formed, as the guide sleeve 4, of two half-shells 16 and can be removed from the sealing member 13.

Below, the use of the leadthrough device 11 will be explained with reference to FIG. 3. The following description equally applies to other embodiments of the inventive leadthrough device shown in other Figures.

The leadthrough device 11 is placed in a formwork for the constructional component 9, e.g., a concrete wall, and is cast in upon formation of the constructional component 9. If the constructional component 9 is formed as a brick constructional component, the leadthrough device 11 can be placed in the constructional component 9 when it is being laid out. When the conduit 10, here an electrical cable, is placed in the leadthrough, device 11, it is pulled, e.g., in the direction of the arrow 17, through the guide sleeve 14 which is arranged in the through-opening 15 of the sealing member 13. Then, the two half-shells 16, which form the guide sleeve 14, are pulled out of the sealing member 13 in the direction of arrows 18, and the sealing member 13, which was compressed at least in the region of the guide sleeve 14, expands again, sealingly abutting the outer wall 19 of the conduit 10.

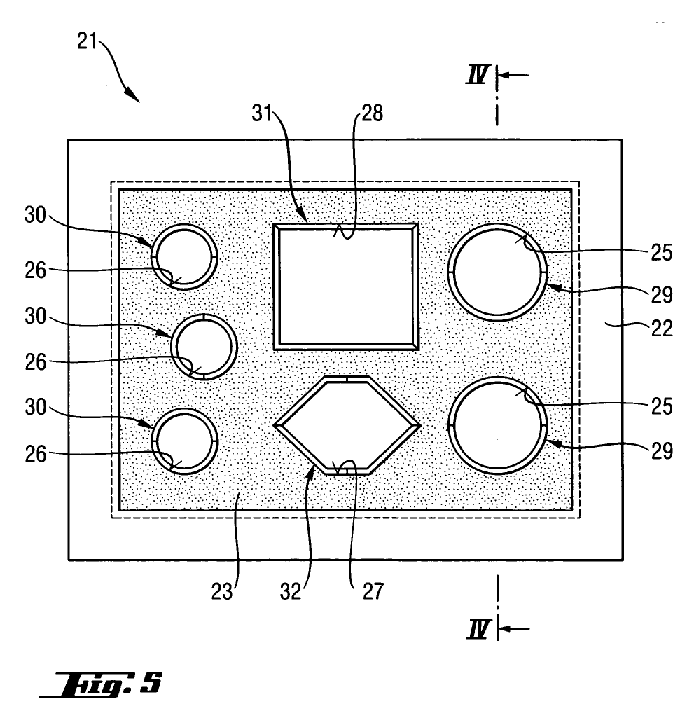

A leadthrough device 21 according to the present invention, which is shown in FIGS. 4-5, has a rectangular frame 22 in which there is arranged an elastic sealing member 23 which also has a rectangular cross-section and is provided with several through-openings 25, 26, 27, 28. The openings 25, 26, 27, 28 have. different cross-sections and dimensions. The through-openings 25, 26 have a circular cross-sections, and two-part guide sleeves 29 and 30 are arranged in the through-openings 25, 26, respectively. The through-opening 27 has a hexagonal cross-section in which a four-part guide sleeve 32 is arranged. The through-opening 28 has a rectangular cross-section in which also a four-part sleeve 31 is arranged. In the guide sleeves 29, removable closing elements 33 are provided. The closing elements 33 are removed when a conduit is placed in the respective through-opening 25.

Though the present invention was shown and described with references to the preferred embodiments, such are merely illustrative of the present invention and are not to be construed as a limitation thereof, and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A leadthrough device (1; 11; 21) for passing a conducting element (10) through an opening (8) formed in a constructional component (9), the leadthrough device comprising an elastic sealing member (3; 13; 23) having at least one through-opening (5; 15; 25, 26, 27, 28); and a removable guide sleeve (4; 14; 29, 30, 31, 32) arranged in the at least one through-opening (5; 15; 25, 26, 27, 28) and having outer dimensions that exceed inner dimensions of the at least one through-opening (5; 15; 25, 26, 27, 28) in the release condition of the elastic sealing member.

2. A leadthrough device according to claim 1, wherein the guide sleeve (4; 14; 29, 30, 31,32) is formed of several parts.

3. A leadthrough device according to claim 2, wherein the guide sleeve (4; 14; 29, 30) is formed of two half-shells (6; 16).

4. A leadthrough device according to claim 1, wherein the sealing member (23) has a plurality of through-opening (25, 26, 27, 28), and wherein the device includes a respective plurality of guide sleeves (29, 30, 31, 32) arranged in respective openings.

5. A leadthrough device according to claim 1, wherein the sealing member (13) is formed of an intumescent material.

6. A leadthrough device according to claim 1, wherein the guide sleeve (29) is provided with at least one removable closing element (33).
